(19) United States
(12) Patent Application Publication
(10) Pub. No.: US 2026/0147351 A1
(43) Pub. Date: May 28, 2026

(54) Method for Determining a Surrounding Representation of a Surrounding of a Vehicle

(71) Applicant: Robert Bosch GmbH, Stuttgart (DE)

(72) Inventors: Jiaying Lin, Magstadt (DE); Johannes Reinhardt, Renningen (DE); Michael Ulrich, Stuttgart (DE); Ruediger Jordan, Stuttgart (DE)

(21) Appl. No.: 19/178,097

(22) Filed: Apr. 14, 2025

(30) Foreign Application Priority Data
Apr. 29, 2024 (EP) 24173085.2

(51) Int. Cl. G05D 1/617; B60W 50/14; G05D 101/15; G05D 111/67

(52) U.S. Cl. CPC G05D 1/617; B60W 50/14; G05D 2101/15; G05D 2111/67

(57) ABSTRACT

A method for determining a surrounding representation of a surrounding of a vehicle includes (i) providing input data, wherein the input data comprises sensor data and feedback data, wherein the sensor data results from a detection of at least one sensor of the vehicle, wherein the sensor data represents a detection of the surrounding of the vehicle, (ii) providing a machine-learning model, wherein the machine-learning model comprises a pre-processing module and at least one task-specific module, (iii) providing the feedback data, wherein the feedback data comprises at least one historical output of the at least one task-specific module and/or at least one historical output of the pre-processing module, wherein the historical output has been determined by the at least one task-specific module and/or the pre-processing module at least one iteration prior to a current iteration, (iv) extracting features from the input data by way of the pre-processing module, and (v) determining, by way of the at least one task-specific module, a respective output based on the features extracted by the pre-processing module and/or the at least one historical output of the at least one task-specific module and/or the at least one historical output of the pre-processing module for the current iteration in order to determine the surrounding representation of the surrounding of the vehicle. An associated computer program, an apparatus, and a storage medium are also disclosed.

This application claims priority under 35 U.S.C. § 119 to patent application no. EP 24173085.2, filed on Apr. 29, 2024 in the European Patent Office, the disclosure of which is incorporated herein by reference in its entirety.

The disclosure relates to a method for determining a surrounding representation of a surrounding of a vehicle. The disclosure further relates to a computer program, an apparatus, and a storage medium for this purpose.

### BACKGROUND

For advanced driver assistance systems and autonomous driving, there are several tasks that derive different aspects of the surrounding from sensor inputs or sensor measurements. In object detection, other road users are detected and classified. In a semantic segmentation, it is determined to which semantic categories a pixel or point of a point cloud belongs. In a “travelable space” task, it is determined which parts of the space are travelable. When road edges, roads, or lanes are detected, the road path is determined in various levels of detail.

In the common paradigm of tracking-by-detection, algorithms for these tasks are divided into a detection algorithm that processes the sensor inputs in a single measurement, followed by a tracking algorithm that takes into account the output of the detector over time. Alternative approaches use deep neural networks for object detection with a memory, e.g. for example, certain layers or a feedback of transformer token in order to carry out the tracking in a feature space.

### SUMMARY

The subject matter of the disclosure is a method, a computer program, an apparatus, and a computer-readable storage medium having the features set forth below. Further features and details of the disclosure will emerge from the description and the drawings. Features and details which are described in connection with the method according to the disclosure naturally also apply in connection with the computer program according to the disclosure, the apparatus according to the disclosure, and the computer-readable storage medium according to the disclosure, and vice versa in each case, so that a reciprocal reference is always possible with regard to the disclosure of the disclosure.

The subject matter of the disclosure is in particular a method for determining a surrounding representation of a surrounding of a vehicle, comprising the following steps, wherein the steps can be repeated and/or performed sequentially. For example, the vehicle can be a passenger car or a utility vehicle. The surrounding of the vehicle is then in particular a traffic surrounding. However, it is also contemplated that the vehicle is a robot.

In a first step, input data is preferably provided, wherein the input data comprises sensor data and feedback data. The sensor data preferably results from a detection of at least one sensor of the vehicle, wherein the sensor data represents a detection of the surrounding of the vehicle. If at least two sensors are provided, then the at least two sensors can be an identical or different type of sensor, respectively. For example, the sensors can each be configured as a camera, radar, lidar, or ultrasonic sensor, wherein this list is not exhaustive. The sensor data can comprise feedback data, radar data, lidar data, and/or ultrasonic data, respectively. The sensor data can represent the surrounding of the vehicle in that it senses or has sensed the surrounding based on the vehicle.

In a further step, preferably a machine-learning model is provided, wherein the machine-learning model comprises a pre-processing module and at least one task-specific module. The pre-processing module can also be referred to and understood as a “backbone” in the context of the present disclosure. The at least one task-specific module can also be referred to and understood as a “detection head” in the context of the present disclosure. Accordingly, the at least one task-specific module can be advantageously configured for a detection and/or classification task. Examples of tasks include object detection, for example, of further road users or even detection of a travelable space. A further possible task would be for visibility to be estimated, i.e. where the sensors can detect something. Furthermore, object detection can be performed with respect to various infrastructures such as traffic lights, bridges, etc. It is also contemplated that a depth estimate will be performed, i.e. a determination of missing 3D coordinates from one or more 2D images. Furthermore, a limitation of sensors can be discovered, e.g. by soiling or ice. The weather in general or a change in the orientation of sensors, for example due to an accident, can also be detected.

In a further step, preferably the feedback data is provided, wherein the feedback data comprises at least one historical output of the at least one task-specific module and/or at least one historical output of the pre-processing module. The historical output was in particular determined by the at least one task-specific module and/or the pre-processing module at least one iteration prior to a current iteration. The iteration can also be referred to and understood as an increment or cycle, and in particular represents an elapsed period of time during which the output was determined.

In a further step, preferably features are extracted from the input data by the pre-processing module. The pre-processing module of the machine-learning model can extract the features from the input data by identifying patterns and correlations in the input data. For example, the model can utilize neural networks, decision trees, or support vector machines. In a corresponding training, the pre-processing module can learn which features in the input data are important for the task-specific module mentioned in that it is trained with the training data and compares the respective results or outputs of the task-specific module to reference data. The extracted features can be different depending on the area of application. For example, the extracted features could represent objects such as vehicles or passersby in the surrounding of the vehicle, or could also be of a more abstract nature and not directly interpretable. In the latter case, the interpretation can then be performed by the at least one task-specific module, respectively.

Preferably, in a further step, by way of the at least one task-specific module, a respective output is determined based on the features extracted by the pre-processing module and/or the at least one historical output of the at least one task-specific module and/or the at least one historical output of the pre-processing module for the current iteration in order to determine the surrounding representation of the surrounding of the vehicle. Accordingly, the particular output can correspond to a particular specific surrounding representation. The output may be, for example, boundary frames for an object detection, semantic markings for pixels or points for a semantic segmentation, a grid map with markings for a travelable surface or an occupancy for a travelable surface, a grid map or a series of parameterized lines for the layout of the road or the travel lane for the detection of road boundaries, roads, or tracks.

In another possible step, a task-specific analysis of the surrounding of the vehicle can be provided based on the determined output of the at least one task-specific module and/or the at least one historical output of the pre-processing module. The task-specific analysis corresponds in particular to an interpretation of the output of the at least one task-specific module and can include, for example, whether there is a particular object or obstacle in the surrounding of the vehicle, or whether a space in front of the vehicle is travelable.

In a further possibility, it can be provided that the feedback data further comprises historical sensor data from the at least one iteration prior to the current iteration and/or historical processed input data from the at least one iteration prior to the current iteration, wherein the extraction is further performed based on the historical sensor data and/or the historical processed input data. It is also contemplated that a combination of different iterations will be used, for example sensor data from the last five iterations, but only processed input data from the last three iterations. By way of the aforementioned older data, an even more differentiated extraction of features can advantageously take place and, as a result, a more precise task-specific analysis of the surrounding.

In addition, it is advantageous when the feedback data comprises the following step:
transforming the historical output using a physical model, wherein the physical model describes at least one movement of the vehicle and/or of at least one object detected by the at least one task-specific module.

Due to the transformation, advantageously, the movement of the vehicle and/or the at least of the object detected by the at least one task-specific module can be considered, and thereby, the determination of the output and task-specific analysis can be performed more precisely. The physical model can also be a learned model, so that the historical output can alternatively also be transformed by the learned model. Further, in addition to the movement, other time-dependent processes can be modeled by the physical model or the learned model.

For example, it can also be provided that at least two sensors are provided and the at least two sensors are at least two different types of sensors. Thus, a different type of sensing of the surrounding can advantageously be provided as sensor data, thereby enabling more differentiated task-specific analysis. For example, it is contemplated that one type of sensor is a radar sensor and another type of sensor is a camera sensor. For example, an analysis of a camera image can advantageously additionally take into account a radar image of the same surrounding.

In addition, it is advantageous for the method to further comprise at least one of the following steps:
initiating a visual or audible notification in the vehicle based on the particular output,
initiating a controlling of the vehicle based on the determined respective output.

For example, the notification can be output via a speaker or a display of the vehicle. For example, the control of the vehicle can be a braking maneuver, such as when the particular respective output indicates that there is an obstacle in a path of travel of the vehicle.

Furthermore, it is contemplated within the scope of the disclosure that the pre-processing module is configured as a convolutional neural network, a transformer or point-processing network, or a combination of these types of networks.

A convolutional neural network (CNN) is in particular a class of deep learning algorithms that can be used primarily in image and video recognition, image classification, object recognition, and similar tasks. CNNs are among the neural networks that, due to their specific architecture, can efficiently capture spatial hierarchies of features in data. For example, a CNN is comprised of a sequence of layers that transform data through different types of operations. Convolutional layers preferably carry out a convolution operation in which filters (or cores) are moved over the input in order to extract features such as edges or textures. In particular, the convolution reduces the dimensionality of the data but retains important spatial information. After each convolution, preferably a non-linear activation function, such as the ReLU function (Rectified Linear Unit), is employed in order to introduce non-linearities to the network and to allow complex patterns to be learned. In particular, pooling layers further reduce the dimensionality of the data through operations such as max pooling or average pooling, where the maximum or average of values are taken in a particular range of the data. This can help reduce computational load and increase robustness over small variations in the data. At the end of the network are preferably one or more fully connected layers that use the learned features in order to carry out specific tasks such as classification. Here, classification is preferably made based on the detected and processed features. The last layer of a CNN, in particular, outputs the network prediction, for example the probabilities of different classes in a classification task.

A transformer processing network, also referred to as a “transformer,” is in particular an architectural model that was originally developed for natural language processing (NLP) tasks. It was first presented in the paper “Attention is All You Need” by Vaswani et al. in 2017. The central innovation of the transformer architecture is in particular the mechanism of self-attention, which can allow the model to weight and interpret the meaning of one word in the context of all the other words in the sentence.

A point-processing network, also referred to more specifically in the context of 3D data as a “pointnet,” is in particular a type of neural network designed so as to directly process point clouds. For example, point clouds are a collection of points in space that represent objects or scenes and are typically captured by 3D scanners or other depth sensors. This data structure can be used for applications in the areas of robotics, autonomous vehicles, augmented reality and 3D modeling where efficient and effective processing of spatial information is required.

It is possible that the method according to the disclosure is used in a vehicle. The vehicle can, for example, be designed as a motor vehicle and/or a passenger vehicle and/or an autonomous vehicle. The vehicle can comprise a vehicle device, e.g., for providing an autonomous driving function and/or a driver assistance system. The vehicle device can be configured so as to control and/or accelerate and/or brake and/or steer the vehicle, at least partially automatically.

In particular, the machine-learning model is trained for classification and/or object detection. Accordingly, the training can result in a trained machine-learning model which can be used for classification and/or object detection. The use, and with it the inference, can be provided in a vehicle, for example. The data points of the input data can be pixels of feedback data or be based on these in order to carry out the classification and/or object detection of the data points on the basis of the pixels. The input information can include sensor and/or feedback data that results at least in part from acquisition by way of a sensor, preferably a camera sensor, and/or which have been at least partially synthesized, i.e. in particular mimic the real data of a sensor. Specifically, it can be provided that the surrounding of a sensor and/or a vehicle and/or a traffic scene is represented by the values of image points, preferably pixels, of the feedback data. Classification, preferably image classification and/or object detection, based on these values can be provided. This makes it possible to detect objects of the traffic scene, for example. The classification can also be provided in the form of semantic segmentation (i.e., pixel-by-pixel or area-by-area classification) and/or object detection. The feedback data can be images of a radar sensor and/or an ultrasonic sensor and/or a LiDAR sensor and/or a thermal imaging camera for example. Accordingly, the images can also be configured as radar images and/or ultrasonic images and/or thermal images and/or lidar images.

Another object of the disclosure is a computer program, in particular a computer program product, comprising commands which, when the computer program is executed by a computer, cause the computer to carry out the method according to the disclosure. The computer program according to the disclosure thus brings with it the same advantages as have been described in detail with reference to a method according to the disclosure.

The disclosure also relates to an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a vehicle with two sensors, an apparatus, a storage medium, and a computer program according to exemplary embodiments of the disclosure,

FIG. 2 A schematic representation of a specific exemplary embodiment of a method according to exemplary embodiments of the disclosure,

FIG. 3 A schematic representation of a possible exemplary embodiment of a method according to exemplary embodiments of the disclosure.

### DETAILED DESCRIPTION

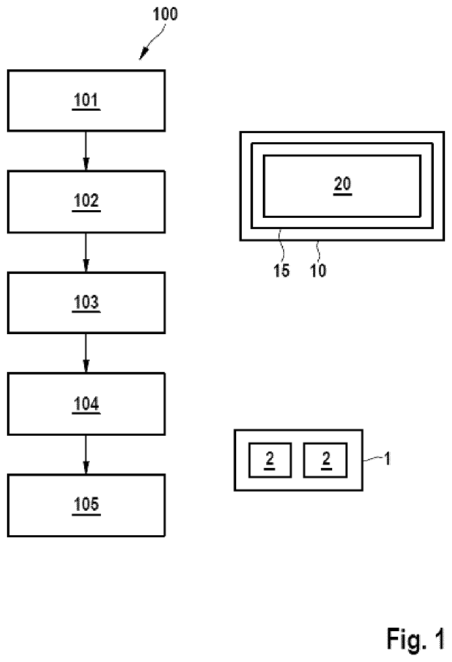

FIG. 1 schematically shows a method 100, a vehicle 1 with two sensors 2, an apparatus 10, a storage medium 15, and a computer program 20 according to exemplary embodiments of the disclosure.

As an alternative to the exemplary embodiment in FIG. 1, a single sensor 2 can also be used in order to carry out the method 100 according to the disclosure.

In particular, FIG. 1 shows an exemplary embodiment of a method 100 for determining a surrounding representation of a surrounding of a vehicle 1. In a first step 101, input data is provided, wherein the input data comprises sensor data 3 and feedback data 4. The sensor data 3 results from a detection of at least one sensor 2 of the vehicle 1, wherein the sensor data 3 represents a detection of the surrounding of the vehicle 1. In a second step 102, a machine-learning model 9 is provided, wherein the machine-learning model 9 comprises a pre-processing module 5 and at least one task-specific module 6. In a third step 103, the feedback data 4 is provided, wherein the feedback data 4 comprises at least one historical output 7 of the at least one task-specific module 6 and/or at least one historical output of the pre-processing module 5, wherein the historical output 7 has been determined by the at least one task-specific module 6 and/or the pre-processing module 5 at least one iteration prior to a current iteration. In a fourth step 104, features are extracted from the input data by the pre-processing module 5. In a fifth step 105, by way of the at least one task-specific module 6, a respective output 7 is determined based on the features extracted by the pre-processing module 5 and/or the at least one historical output 7 of the at least one task-specific module 6 and/or the at least one historical output of the pre-processing module 5 for the current iteration in order to determine the surrounding representation of the surrounding of the vehicle 1.

In a further possible step, a task-specific analysis of the surrounding can be provided based on the determined output 7 of the at least one task-specific module 6.

One aspect of the present disclosure is in particular a use of a machine-learning model 9, e.g. a neural network, that utilizes temporal feedback and performs multiple tasks simultaneously.

The method according to the disclosure can allow the temporal context to be considered and can exploit the high temporal correlation of the inputs and outputs of the machine-learning model 9.

Moreover, using a single machine-learning model 9 to solve multiple tasks (a so-called multitask network) has additional advantages over machine-learning models for individual tasks: It can provide more accurate and robust results for each task, because the machine-learning model 9 can learn more general features. For example, less training data is needed because the backbone, or pre-processing module 5, can be commonly used by all task-specific modules 6. Less computational effort and hardware requirements may be required, because the evaluation of the pre-processing module 5 can be commonly used by all task-specific modules 6.

The advantages of an explicit feedback of an output of machine-learning model 9 back to the input of the next increment are as follows: In particular, no further network layers are required except for an additional network input. Therefore, in particular, the requirements for the amount of the training data do not increase significantly compared to the single image detection. The inclusion of data from multiple increments may require a compensation for the movement of the ego vehicle as well as the movement of the objects in the surrounding of the vehicle 1. This can be easily possible with the approach according to exemplary embodiments of the disclosure, e.g. using physical models 8, such as the predictive step of a Kalman filter. By contrast, the motion compensation with implicit representations in the feature space is a challenge.

For example, the method according to exemplary embodiments of the disclosure is applicable in situations where sensors 2 are employed in order to measure a dynamic surrounding. This may be, for example, in driver assistance and automated driving, where sensor data 3 from camera, radar, and lidar is used in order to estimate other road users, road travel, and semantic maps of the surrounding. Other applications could include internal and external robotics, safety systems, and warehouse logistics.

Such a machine-learning model 9 in terms of a feedback network could be employed in the perceptron. For example, the perceptron is positioned at the beginning of a processing stack and can receive pre-processed sensor data 3 from previous levels, and the output of the perceptron can be used by later levels. For example, in a driving assistance system, the machine-learning model 9 could receive a de-warped image from a camera sensor and radar reflections from multiple radar sensors, and the output of the machine-learning model 9 can be used for further processing of the surrounding model, planning, and action.

This feedback mechanism is based in particular on successive sensor measurements being temporally correlated so that it is possible to obtain information about the world from earlier increments in the current increment.

For example, weak radar locating in a particular region of the space is more likely to be indicative of a vehicle or other road user at that time when a vehicle or other road user has been discovered in that area during the previous iteration, or in the previous increment, respectively.

For example, the multitasking mechanism exploits the fact that the tasks are not independent. For example, it is less likely that a radar position will be indicative of a vehicle or other road user when the pixels of the camera image in this region of the space are classified as vegetation by the semantic segmentation.

By combining both methods, correlations over time and across tasks can be exploited.

For example, it is less likely that a camera pixel will belong to the vegetation if a moving object has been detected in the vicinity during a previous iteration or previous increment.

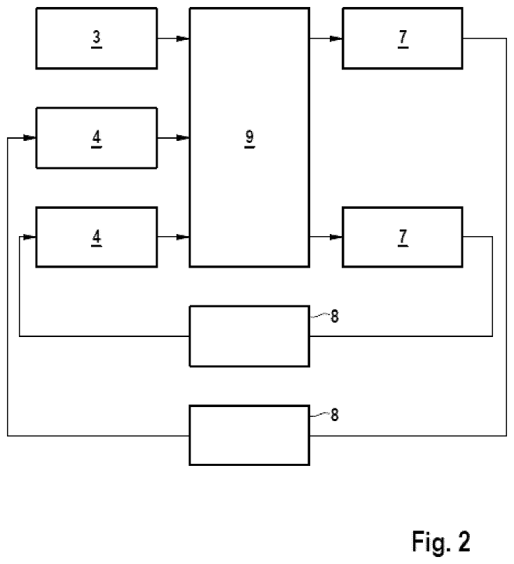

As a specific example according to FIG. 2, the machine model 9 can estimate a travelable space and detect objects based on radar reflections. For each measurement cycle of the radar sensor, in particular, the measured reflections are entered as feedback data 4 of the last cycle into the machine model 9 as sensor data 3 along with the motion-compensated outputs 7 using a physical model 8.

In particular, the compensation functions somewhat differently for the travelable space, where only the ego-movement of the vehicle 1 is compensated using the physical model 8 and for detected objects where the movement of the detected object can additionally be taken into account using the physical model 8.

Through the feedback, the network can learn to track objects, take advantage of the temporal context, provide use of cross-task information, and combinations thereof.

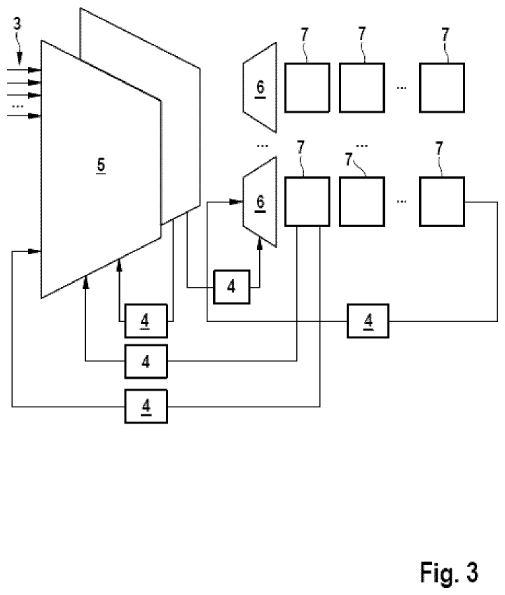

A diagram of the data flow according to an exemplary embodiment through a general machine-learning model 9 is shown in FIG. 3. The machine-learning model 9 comprises a pre-processing module 5 and a plurality of task-specific modules 6. The input for machine-learning model 9 is sensor data 3 for the increment t and the feedback data 4. The sensor data 3 can be from one or more sensors 2 of an identical or different sensor type. For example, this can be location data or spectra from one or more radar sensors, images from one or more camera sensors, point clouds from one or more lidar sensors, or also any learned feature spaces from an upstream machine-learning model.

For example, feedback data 4 is data from earlier increments, e.g. from a previous iteration, a previous increment, or from even older iterations or increments. The feedback data 4 can include the output 7 of the task-specific module 6, or detection head, of the pre-processing module 5, or backbone, or any intermediate layer from an earlier increment. This feedback can enter into the machine-learning model 9 at the beginning of the pre-processing module 5 along with the sensor data 3, on any layer within the pre-processing module 5, or on any layer of a task-specific module 6. In particular, because feedback connections link layer data to different timestamps, the target level may lie upstream or downstream of the source level in terms of data flow. FIG. 3 shows some possibilities for feedback connections, i.e. connections for the feedback data 4. Feedback connections can include calculations in the form of explicit transformations (such as dynamic detected object motion prediction or compensation for ego movements of the vehicle 1 using physical models 8) or additional learned layers, such as Long Short-Term Memory (LSTM) layers, additional convolutional layers, pooling, or other up- or down-sampling layers.

The sensor data 3 is then preferably transformed by the pre-processing module 5 of the machine-learning model 9, which can be realized, for example, as a convolutional neural network (CNN), transformer, or point-processing network, or a combination of these types of networks.

The output of the pre-processing module 5 is in particular a set of abstract, general features and is preferably fed into one or more task-specific modules 6, which determine from these general features a task-specific output 7 for the increment and/or the iteration t, respectively. The output 7 may be, for example, boundary frames for object detection, semantic markings for each pixel or point for semantic segmentation, a grid map with markings for the travelable surface or the occupancy for the travelable surface, a grid map or a series of parameterized lines for the layout of the road or the travel lane for the detection of road boundaries, roads, or tracks.

Such a machine-learning model 9 can be trained in a monitored, semi-monitored, or unsupervised manner.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for determining a surrounding representation of a surrounding of a vehicle, comprising:
providing input data, wherein the input data comprises sensor data and feedback data, wherein the sensor data results from a detection of at least one sensor of the vehicle, and wherein the sensor data represents a detection of the surrounding of the vehicle;
providing a machine-learning model, wherein the machine-learning model comprises a pre-processing module and at least one task-specific module;
providing the feedback data, wherein the feedback data comprises at least one historical output of the at least one task-specific module and/or at least one historical output of the pre-processing module, and wherein the historical output has been determined by the at least one task-specific module and/or the pre-processing module at least one iteration prior to a current iteration;
extracting features from the input data by way of the pre-processing module; and
determining, by way of the at least one task-specific module, a respective output based on the features extracted by the pre-processing module and/or the at least one historical output of the at least one task-specific module and/or the at least one historical output of the pre-processing module for the current iteration in order to determine the surrounding representation of the surrounding of the vehicle.

2. The method according to claim 1, further comprising:
providing a task-specific analysis of the surrounding of the vehicle based on the determined output of the at least one task-specific module and/or the at least one historical output of the pre-processing module.

3. The method according to claim 1, wherein:
the feedback data further comprises historical sensor data from the at least one iteration prior to the current iteration and/or historical processed input data from the at least one iteration prior to the current iteration, and
the extraction is further performed based on the historical sensor data and/or the historical processed input data.

4. The method according to claim 1, wherein the provision of the feedback data further comprises:
transforming the historical output using a physical model, wherein the physical model describes at least one movement of the vehicle and/or of at least one object detected by the at least one task-specific module.

5. The method according to claim 1, wherein:
at least two sensors are provided, and
the at least two sensors are at least two different types of sensors.

6. The method according claim 1, wherein the at least one task-specific module is configured for a detection and/or classification task.

7. The method according to claim 1, further comprising:
initiating a visual or audible notification in the vehicle based on the determined respective output; or
initiating a controlling of the vehicle based on the determined respective output.

8. The method according to claim 1, wherein the pre-processing module is configured as a convolutional neural network, a transformer or point-processing network, or a combination of these types of networks.

9. A computer program comprising instructions for causing a computer to carry out the method according to claim 1 when the computer program is executed by the computer.

10. An apparatus for data processing, configured so as to carry out the method according to claim 1.

11. A computer-readable storage medium, comprising instructions which, when executed by a computer, cause it to carry out the steps of the method according to claim 1.
